(19) United States
(12) Patent Application Publication
(10) Pub. No.: US 2018/0247568 A1
(43) Pub. Date: Aug. 30, 2018

(54) APPARATUS AND METHOD FOR SMART SAND TABLE DEMONSTRATION

(71) Applicants: Microduino Inc., Westlake Village, CA (US); Meike Technology (Beijing) Ltd., Beijing (CN)

(72) Inventors: Zhenshan WANG, Beijing (CN); Hao CHEN, Beijing (CN); Xi LI, Beijing (CN); Kejia PAN, Beijing (CN); Bin FENG, Westlake Village, CA (US)

(21) Appl. No.: 15/905,493

(22) Filed: Feb. 26, 2018

(30) Foreign Application Priority Data
Feb. 25, 2017 (CN) 201710105232.7
Feb. 25, 2017 (CN) 201720173407.3

(51) Int. Cl. G09B 29/12

(52) U.S. Cl. CPC G09B 29/12; G06F 3/0484

(57) ABSTRACT

Apparatus and method for smart sand table demonstration are provided. The demonstration apparatus includes: a sand table base, a sensor device, a demonstration device and a controller. The sensor device is placed on the sand table base which is also used as a demonstration carrier for the demonstration device. The sensor device includes a sensor module and a first wireless communication module, for monitoring a status of the sensor module and transmit the status information to the controller through a wireless connection. The controller determines demonstration information based at least one of smart demonstration project information and the status information, and transmits the demonstration information to the demonstration device. The demonstration device analyzes the received demonstration information and performs demonstration actions.

### CROSS-REFERENCES TO RELATED APPLICATION

This application claims the priority of Chinese Patent Application No. 201710105232.7, filed on Feb. 25, 2017, and Chinese Patent Application No. 201720173407.3, filed on Feb. 25, 2017, the content of which is incorporated herein by reference in its entirety.

### TECHNICAL FIELD

The present disclosure generally relates to the field of sand table demonstration technologies and more particularly, relates to a smart sand table demonstration apparatus and its demonstration method.

### BACKGROUND

Conventional sand table systems usually only include static models and exhibition in monotonous forms. Even interactive sand table systems can only achieve a single effect with simple mechanical structures (such as doors that can be open or closed manually) or simple switch/driving circuits (such as turning lights on or off). Moreover, electronic devices in the sand table systems have to be connected to data ports of controllers by wires, to accomplish interactive functions.

However, there is a need for an apparatus and a method for smart sand table demonstration that can be used for some complicated demonstration and interaction with electronic devices. The disclosed apparatus and methods are directed to at least partially alleviate one or more problems set forth above and to solve other problems in the art.

### SUMMARY

One aspect of the present disclosure provides a smart sand table demonstration apparatus. The apparatus includes: a sand table base, a sensor device, a demonstration device, and a controller. The sand table base is used as a demonstration carrier for the demonstration devices. The sensor device is placed on the sand table base and includes a sensor module and a first wireless communication module for monitoring a status of the sensor module and transmitting status information to the controller through wireless connections. The controller determines demonstration information based on at least one of smart demonstration project information and the status information of the sensor module, and transmits the demonstration information to the demonstration device. The demonstration device analyzes the received demonstration information and performs demonstration actions corresponding to the demonstration information.

Another aspect of the present disclosure provides a method for smart table demonstration using an apparatus including a sand table base, a sensor device, a demonstration device and a controller. The method includes: establishing a wireless connection between the controller and the sensor device, the sensor device is placed on the sand table base; establishing a connection between the controller and the demonstration device; loading smart demonstration project information; receiving status information monitored and collected by the sensor device; determining demonstration information based on one or more of the smart demonstration project information and the status information; and transmitting the demonstration information to the demonstration device for analyzing the demonstration information and performing demonstration actions corresponding to the demonstration information. The demonstration device has a demonstration carrier including the sand table base.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a structural block diagram for an exemplary smart sand table demonstration apparatus according to various embodiments of the present disclosure;

FIG. 2 illustrates a structural block diagram for another exemplary smart sand table demonstration apparatus according to various embodiments of the present disclosure;

FIG. 3 illustrates an exemplary smart sand table according to various embodiments of the present disclosure;

FIG. 4 illustrates a structural block diagram for an exemplary electronic device according to various embodiments of the present disclosure;

FIG. 5 illustrates a structural block diagram of examples for a sensor device, a demonstration device and a mobile device according to various embodiments of the present disclosure;

FIG. 6 illustrates an exemplary method for smart table demonstration according to various disclosed embodiments of the present disclosure;

FIG. 7 illustrates another exemplary method for smart table demonstration according to various disclosed embodiments of the present disclosure;

FIG. 8A illustrates a top view of an exemplary smart sand table demonstration project according to various embodiments of the present disclosure;

FIG. 8B illustrates an exemplary mobile prop in the smart sand table demonstration project in FIG. 8A according to various embodiments of the present disclosure;

FIG. 9 illustrates a three-dimensional structure for the smart sand table demonstration project in FIG. 8A according to various embodiments of the present disclosure; and

FIG. 10 illustrates a three-dimensional structure for another exemplary smart sand table demonstration project according to various embodiments of the present disclosure.

### DETAILED DESCRIPTION

Reference may now be made in detail to exemplary embodiments of the disclosure, which are illustrated in the accompanying drawings. Wherever possible, the same reference numbers may be used throughout the drawings to refer to the same or like parts.

The present disclosure provides a smart sand table demonstration apparatus and a method for smart table demonstration. The smart table demonstration apparatus may include a smart table base; a sensor device; a demonstration device; and a controller. The sensor device and demonstration device may be deployed on the smart table base. The demonstration device may include a projecting device to project images on a surface of the smart table base. The sensor device and the demonstration device may be composed of various electronic modules. The electronic modules in the present disclosure may also refer to modules or electronic building blocks.

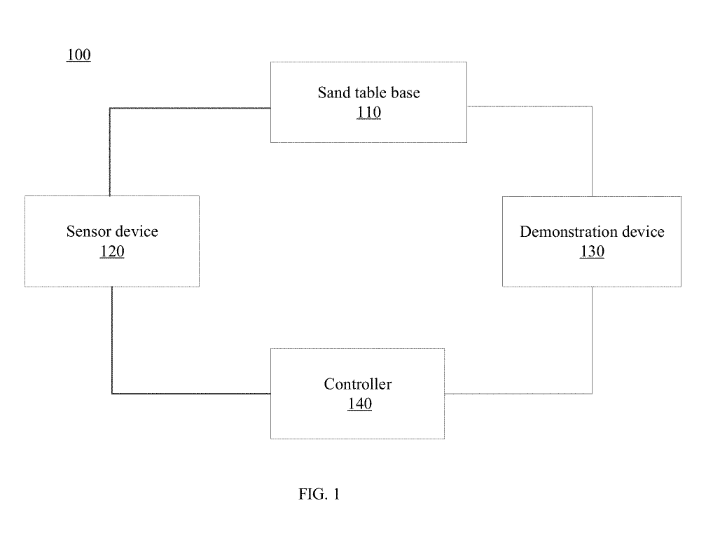

FIG. 1 illustrates a structural block diagram of a smart sand table demonstration apparatus provided by various embodiments of the present disclosure. The smart sand table demonstration apparatus 100 may include a sand table base 110, a sensor device 120, a demonstration device 130 and a controller 140. The sand table base 110 may host the sensor devices 120 and be used as a demonstration carrier for the demonstration device 130. The sand table base 110 may include one or more static sand table scenery structures. The sensor device 120 may include a sensor module and a first wireless communication module for monitoring a status information of the sensor module and transmitting the status information to the controller 140 through wireless connections. The controller 140 may determine the demonstration information based on at least one of the smart demonstration project information and the status information, and to transmit the demonstration information to the demonstration device 130. The demonstration device 130 may analyze the received demonstration information and perform demonstration actions corresponding to the demonstration information.

In various embodiments, the sensor module and the first wireless communication module in the sensor devices 120 may be connected physically and electrically. Different types of the sensor module may be used according to the different interactive demonstration projects. A plurality of sensors with same or different types may be placed on one sand table base 110. The sensor device 120 may be combined with one of the sand table scenery structures to form an interactive scene related to contents of the smart demonstration projects. The sensor module may be one or more of a temperature sensor, a humidity sensor, a light illuminating sensor, an air quality sensor, a human body sensing sensor, a color identifying sensor, a proximity sensor, a collision sensor, a posture sensor, a heart rate sensor, a gesture sensor, an ultrasonic sensor, a Hall sensor, a voice collector and an image collector.

In various embodiments, the demonstration device 130 may include a projecting device, and the demonstration information may include projecting information. The projecting device may receive the projecting information from the controller 140 and project the projecting information onto the sand table base 110. In other embodiments, the demonstration device 130 may further include response devices and second wireless communication modules. The second wireless communication modules may receive the demonstration information from the controller 140 and transmit the demonstration information to the response devices wirelessly. The response devices may be placed on the sand table base 110 and may perform demonstration actions corresponding to the demonstration information. The response devices may be further combined with the sand table scenery structures, to form the interactive scenes related to the contents of the smart demonstration projects. Each second wireless communication module may be connected to and control one or more response devices electrically. The response devices may be one or more of a display, a media player, a LED lamp, a buzzer, a speaker and a motor.

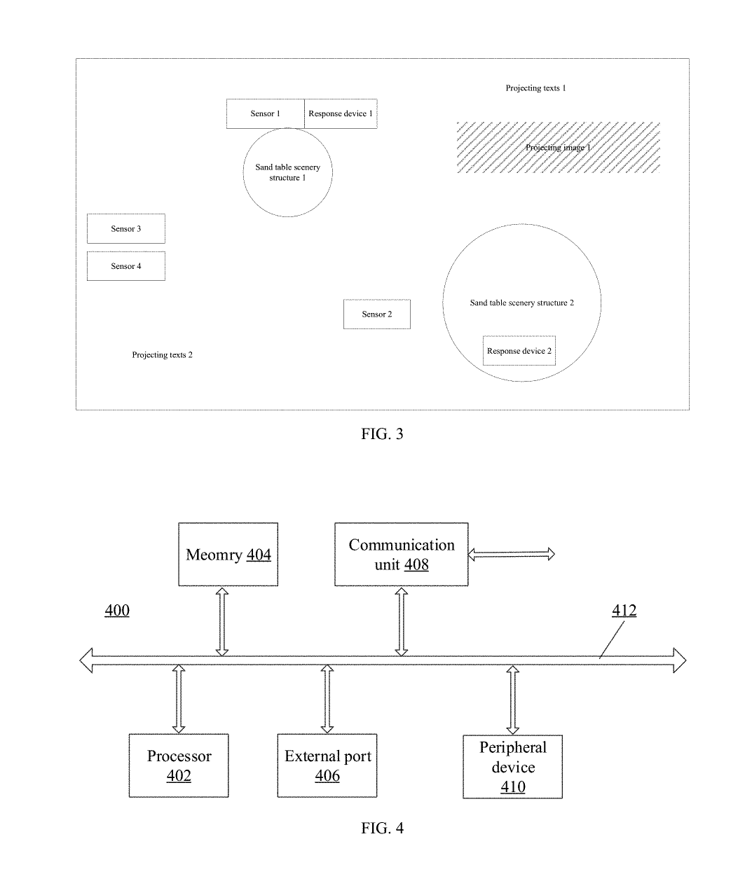

FIG. 3 illustrate a smart table provided by various embodiments of the present disclosure. Different types of sensors and response devices may be placed in or on the surfaces of the sand table base 110. The sensors and response devices may be combined with the sand table scenery structures to provide an interesting and intuitive demonstration. For example, the sand table illustrated in FIG. 3 may be used to demonstrate a community model, and the sand table scenery structure may include several static landscapes such as houses, roads and vegetation. A sand table scenery structure 1 may demonstrate a scene of a parking garage. A plurality of automobile models may be placed on parking lots. Sensor 1 may be light illuminating sensors. A sensor 1 may monitor changes of the light illumination when the automobile models leave or occupy the parking lots, and notify the controller 140 wirelessly. Based on the parking garage demonstration project information and the status information of the sensor 1, the controller 140 then may instruct the response devices 1 to respond correspondingly, such as to display the number of the available parking lots. In another example, the sand table scenery structure 2 may demonstrate a house model, and the response devices 2 may be steering gears connected to doors. When a sensor 2 detects status changed caused by user interactions (such as pressing a doorbell or approach of a prop detected by NFC devices), the controller 140 may instruct the steering gears of the response devices 2 to open or close the doors based on the status information of the sensor 2.

The sand table base 110 may also serve as a carrier for the projecting device. In various embodiments, the projecting device may be deployed above the sand table base 110 and may project information directly onto the upper surface of the sand table base 110. In other embodiments, the sand table base 110 may be a transparent plate and the projecting device may be deployed below the sand table base 110. Correspondingly, the demonstration information may be projected from bottom to top. The projecting information may change in real time according to the user interaction. For example, the controller 140 may instruct the projecting device to display projecting images 1 and projecting texts 1 when the sensor 3 is triggered; but instruct the projecting devices to display projecting texts 2 instead when the sensor 4 is triggered.

The controller 140, also referring to a smart demonstration server, may be connected to the sensor device 120 and the demonstration device 130. The controller 140 may determine or retrieve a model and status of the sensor device 120, based on connecting status and status information of the sensor device 120. The controller 140 may also determine or retrieve a model and a status of the demonstration device 130, based on the connecting status of the demonstration device 130. The controller 140 may maintain a number and status of all the electronic devices connected with the controller 140, as well as the corresponding relationship between the demonstration projects and the electronic devices according to the stored preset demonstration project information. Further, the controller 140 may respond to the sensor device 120 and determine the demonstration information that needs to be sent to the demonstration device 130, according to the preset demonstration rules of the demonstration projects. In the example illustrated in FIG. 3, the controller 140 may identify the demonstration projects corresponding to the sensors 1-4, the response devices 1-2 and the projecting device, respectively. Subsequently, the controller 140 may instruct the response device 1 to respond when the status information of the sensor 1 is received, and may instruct the projecting device to demonstrate correspondingly when the status information of the sensor 3 and the sensor 4 is received.

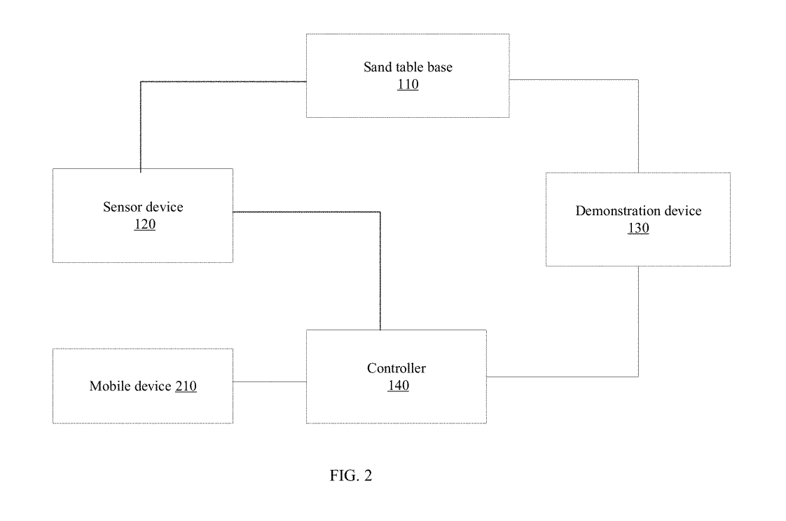

FIG. 2 illustrates a structural block diagram of another smart sand table demonstration apparatus provided by various embodiments of the present disclosure. The smart table demonstration apparatus may further include mobile devices 210 based on FIG. 1. In various embodiments, the mobile devices 210 may be mobile props for the sand table scenes, such as the automobile models, remote controlling devices and navigation devices. The mobile props may include wireless communication modules to communicate with the controller 140. The mobile props may also interact with the sensor device 120. The mobile props may further include sensors and/or response devices, so they can communicate with the controller 140 based on the demonstration projects to provide the status information or to demonstrate corresponding information based on the instructions. For example, the mobile props may function as a navigation apparatus. The controller 140 may receive related information and instruct the corresponding response devices to demonstrate effects when users use the mobile props to trigger specific sensors.

In various embodiments, the mobile devices 210 may include a user terminal, such as a cell phone or a tablet. Application programs corresponding to the smart table demonstration apparatus may be installed on a user terminal, and user interfaces of the application programs may provide demonstration project information and interactive control options. The user terminal then may generate user controlling information based on user inputs on the interactive user interfaces. Correspondingly, the controller 140 may also receive the control information from the user terminal. Subsequently, the controller 140 may determine the demonstration information based on at least one of the smart demonstration information, status information and user control information. The controller 140 may further determine the feedback information based at least one of the smart demonstration information, status information and user control information, and send the feedback information to the user terminal. The feedback information may be demonstrated on the user terminal by the application programs in a form including one or more of displaying, sound and vibration.

The user terminal may be wirelessly connected to the controller 140. In various embodiments, the user terminal may be connected to the controller 140 by WiFi, Bluetooth or infrared connections. In other embodiments, the user terminal and the controller 140 may be connected to a cloud server respectively. Then the user terminal and the controller 140 may communicate with each other through the cloud server. The cloud server may further be connected to the internet. The user terminal with administrative authority can also monitor the running status of the smart sand table demonstration apparatus remotely, while the user terminal with normal viewing authority can browse in advance or review the smart sand table demonstration information through the application programs, and perform various interaction at the scenery locations.

FIG. 4 illustrates a structure of electronic devices in the present disclosure. Each electronic device of the sensor device 120, the demonstration device 130 (such as the projecting device and the response devices), the mobile devices 210 (such as the mobile props and the user terminals) and the controller 140 in the present disclosure may include all of or a portion of the hardware structure in FIG. 4. As illustrated in FIG. 4, each electronic device 400 may include a processor 402, a memory device 404, an external port 406, a communication module 408, a peripheral device 410, and a bus 412 connecting all above components.

The electronic device illustrated in FIG. 4 is for exemplary only. In various embodiments, each electronic device may have more or fewer components than the illustrated components. Also, each electronic device may have one or more of the same component, and two or more components may be combined. The components may be configured differently, or arranged differently. Each component in FIG. 4 may be implemented in hardware, software or a combination of hardware and software. Each component may include one or more signal processing integrated circuits and/or specific integrated circuits. In various embodiments, the processor 202, the memory device 404, the external port 406, the communication module 408 and the bus 412 may be implemented in one chip or in independent chips respectively.

The memory device 404 may be used to store the application programs. Through executing the application programs stored in the memory devices 404, the processor 402 may execute various functional applications and data processing, such as identifying/controlling the functional modules connected with the external port, analyzing the data information received by the communication module, reading and executing the demonstration project information. The memory device 404 may include a high-speed random accessed memory or a non-volatile memory, such as at least one of magnetic disk memory devices, flash memory devices or other volatile solid memory devices. Correspondingly, the memory device 404 may further include a memory controller, to implement accessing of the memory device 404 by the processor 402, the external port 406 and the peripheral device 410.

The communication module 408 may be used to receive and send electromagnetic waves, and implement mutual conversion between the electromagnetic waves and the electrical signals for communication with communication networks or other devices. The communication module 408 may include various existing circuit components for performing above functions, such as antennas, radio frequency transceivers, digital signal processors, encryption/decryption chips, memories, and so on. The communication module 408 may communicate with various networks or may communicate with other devices through wireless networks. The communication module 408 may support one or more of communication standards, protocols, and technologies, including but not limited to infrared, Bluetooth, wireless personal area network (WPAN) standards, voice over internet protocol (VoIP), worldwide interoperability for microwave access (Wi-Max), or any other suitable communication protocols. The communication module 408 may even support communication protocols that have not been developed so far. The external port 406 may include a hardware port (such as a data port or a signal port), to connect or control various peripherals, such as monitors, projectors and so on. The external port 406 may also be used to connect various electronic functional modules for combining various functions. The peripheral device 410 may include various input/output devices, such as indicators, switches, speakers, touch screens, cameras, and so on.

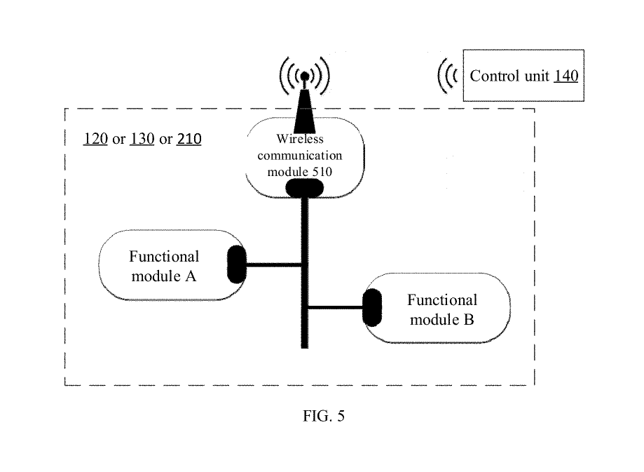

FIG. 5 illustrates a structure of the sensor device, demonstration device and mobile devices according to various embodiments of the present disclosure. Each sensor device 120, demonstration device 130 and mobile device 210 (such as mobile prop) may include a same wireless communication module 510 and one or more functional modules. The wireless communication module 510 may be connected to one or more functional modules electrically. The wireless communication module 510 may be used to establish a connection with the controller 140 and perform the wireless communication, to transmit the status information or demonstration information of the connected functional modules. The communication method may be one or more of a Bluetooth communication, an infrared communication and a WiFi communication. In some embodiments, the wireless communication modules 510 of some or all the electronic devices may be wirelessly connected to a router and then communicate with controller 140 through the router. In other embodiments, the wireless communication modules 510 of some or all the electronic devices may be directly connected to the controller 140.

When a functional module is connected to a wireless communication module 510 through a matching port, the wireless communication module 510 can interact with the connected functional module for data information. Usually, the different functional modules may have same peripheral hardware ports, which match the ports of the wireless communication modules 510. The functional modules, also referring to the functional electronic modules or the specific functional electronic modules, may include display modules, media player modules, motor driver modules, sensor modules (such as a temperature sensor, a humidity sensor, a light illuminating sensor, an air quality sensor, a human body sensing sensor, a color identifying sensor, a proximity sensor, a collision sensor, a posture sensor, a heart rate sensor, a gesture sensor, an ultrasonic sensor, a hall sensor, a touch sensor, and so on.), communication modules, voice collecting modules and image collecting modules. An entity of a functional module may implement one specific function or integrate multiple functions. Some functional modules may be used as the sensor device 120 and others may be used as the demonstration device 130.

In various embodiments, each sensor device 120 may include one wireless communication module 510 and one or more sensing functional modules connected to the wireless communication module, while each response device may include one wireless communication module 510 and one or more response functional modules connected to the wireless communication module. A wireless communication module 510 may connect one sensing functional module and one response functional module. Correspondingly, the combination of the wireless communication module 510 and the sensing functional module may be used as a sensor device 120, and the combination of the wireless communication module 510 and the response functional module may be used as a demonstration device 130. The wireless communication modules 510 may identify the models and categories of the connected functional modules, or may send the data of the connected functional modules to the controller 140 which may identify and analyze the data. After the wireless communication modules 510 receive the data from the controller 140, the wireless communication modules 510 may dispatch the instructions to the corresponding functional modules for execution according to the identified models of the connected functional modules.

In some embodiments, the wireless communication modules 510 of different electronic devices may realize a self-organized network. The wireless connection between the wireless communication modules 510 of different electronic devices and/or the wireless connection of the electronic devices with the controller 140, may be realized by the Internet of Things technology. The wireless communication modules 510 may support the communication protocols of Internet of Things, including a wireless personal area network (WPAN) protocol and an IPv6 over Low Power Wireless Personal Area Network (6LoWPAN) protocol based on the IEEE802.15.4 standard. In the default configuration, the networking function of the wireless communication modules 510 can be enabled. In this case, all the wireless communication modules 510 in the default configuration can discover each other within the communication distance and automatically establish a network connection. The function of ad hoc network is to discover the surrounding available devices (that is, other wireless communication modules 510 that can be connected) and to establish the connection between the wireless communication modules 510 to form the Internet of Things. After the internet of things is established, each wireless communication module 510 can be regarded as a network node, and each wireless communication module 510 can obtain related information of any node in the network. The controller 140 may also support the Internet of Things protocol and act as one node in the network. Alternatively, the controller 140 may be connected with the wireless communication module 510 of any one node in the Internet of Things or the functional module connected thereto via another communication protocol, and the information of other nodes in the Internet of Things may be transmitted through this communication protocol to the controller 140.

The first wireless communication module and the second wireless communication module may also be used to establish a wireless connection with each other. When the first wireless communication module is in the range of the wireless signal of the controller 140 and the second wireless communication module is not in the range of the wireless signal of the controller 140, the second wireless communication module may communicate with the controller 140 through the first wireless communication module as long as the second wireless communication module is in the range of the wireless signal of the first wireless communication module.

When the sand table demonstration apparatus includes a plurality of sensor device, the first wireless communication nodule of one sensor device may be used to establish a wireless connection with the first wireless communication module of another sensor device. When the sand table demonstration apparatus includes a plurality of demonstration device, the first wireless communication module of one demonstration device may be used to establish a wireless connection with the first wireless communication module of another demonstration device. Further, the first and second wireless communication modules may be used to establish a wireless network including a plurality of sensor devices and demonstration devices.

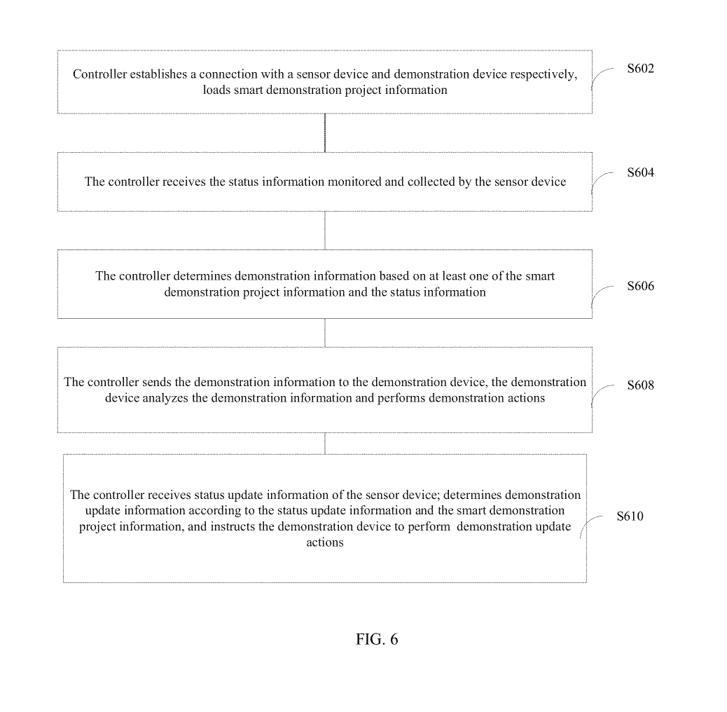

FIG. 6 illustrates a method for the sand table demonstration according to various embodiments of the present disclosure. The sand table demonstration method may be used in various embodiments of the sand table demonstration apparatus illustrated in FIGS. 1-5. The method may include following steps.

As shown in Step S602 in FIG. 6, a wireless connection between the sensor device and the controller may be established; a wireless connection between the demonstration device and the controller may be established; and the smart demonstration project information is loaded. The sensor device may be fixed on the sand table base, and may include a sensor module and a first wireless communication module connected to each other. The first wireless communication module may be used to monitor the status information of the sensor module and transmit the status information to the controller through the wireless connection. The demonstration device may include a projecting device to project the information on the sand table base and produce demonstration effect combing actual and virtual effects. The demonstration device may further include response modules and the second wireless communication module. The second wireless communication module may receive the demonstration information from the controller and dispatch the demonstration information to the corresponding response modules. The response modules may be fixed on the sand table base and execute demonstration actions according to the demonstration information.

The smart demonstration project information may be stored in a database in conjunction with the controller. Administrators may preset the smart demonstration project information. The smart demonstration project information may include preset rules related to the sensor device, demonstration device and/or mobile devices. One example of the smart demonstration project information is the demonstration information which may be generated and the corresponding demonstration device when some specific preset conditions are met (such as reaching a preset time or receiving specific information from the sensor device and/or mobile devices). The demonstration information may be images or videos for the projecting device, or control information for the response devices (such as signals to turn on/off motors).

As illustrated in Step S604 in FIG. 6, the controller may receive the status information of the sensor device. The sensor device may be used for interactive demonstration, and users may trigger the sensor device in the sand table base according to different demonstration projects. In various embodiments, the sensor devices may send information to the controller when detecting a change in the status (such as reaching a certain threshold value), or may send status information to the controller in real time (for example, send information to the controller every 5 seconds according to a preset sampling frequency). In other embodiments, the sensor device may be in a sleep state when it is not in use, and send information to the controller after waking up for a preset period of time (for example, continuously sending information to the controller with 5 minutes after waking up).

As illustrated in Step S606 in FIG. 6, the controller may determine corresponding demonstration information based on at least one of the smart demonstration project information and the status information. When detecting that the status information of the sensor device meets the preset rules or other preset conditions specified by the smart demonstration project information, the controller may determine the demonstration information according to the preset rules. In various embodiments, the controller may maintain a historical record of variables which are necessary for the demonstration projects. For example, the controller may revise the variable information according to the status information and then update the corresponding demonstration information according to the revised variable information, when the sensor devices change the status once.

In various embodiments, the demonstration information may be used by a plurality of the demonstration device. For example, the demonstration information may include preset images for the projecting device and control signals for the response devices (such as the controlling signals for the buzzers and indicating lamps).

As illustrated in Step S610 in FIG. 6, the controller may send the demonstration information to the corresponding demonstration device. If the demonstration information includes signals for a plurality of demonstration device, the controller may dispatch the corresponding demonstration information to each demonstration device. The demonstration device may analyze the received demonstration information and perform corresponding demonstration actions. In various embodiments, one projecting device may be used for a plurality of demonstration projects. For example, a plurality of interactive sessions may be set up in one sand table, and the images projected on the sand table by the projecting device may change according to the demonstration information for different interactive sessions.

In various embodiments, the smart table demonstration method may further include Step S610 in FIG. 6, including: receiving status update information of the sensor devices; determining the demonstration update information according to the status update information and the smart demonstration project information; and instructing the demonstration device to perform corresponding demonstration update actions according to the demonstration update information. The controller may respond differently to the status information for different cases. In various embodiments, the controller may load information for multiple demonstration projects and control the running of the multiple demonstration projects simultaneously. The controller may determine sources and types of the information after receiving the status information from the sensor device, and then find out the information of the corresponding demonstration projects. Subsequently, the controller may determine the corresponding demonstration information which may be sent to the corresponding demonstration device.

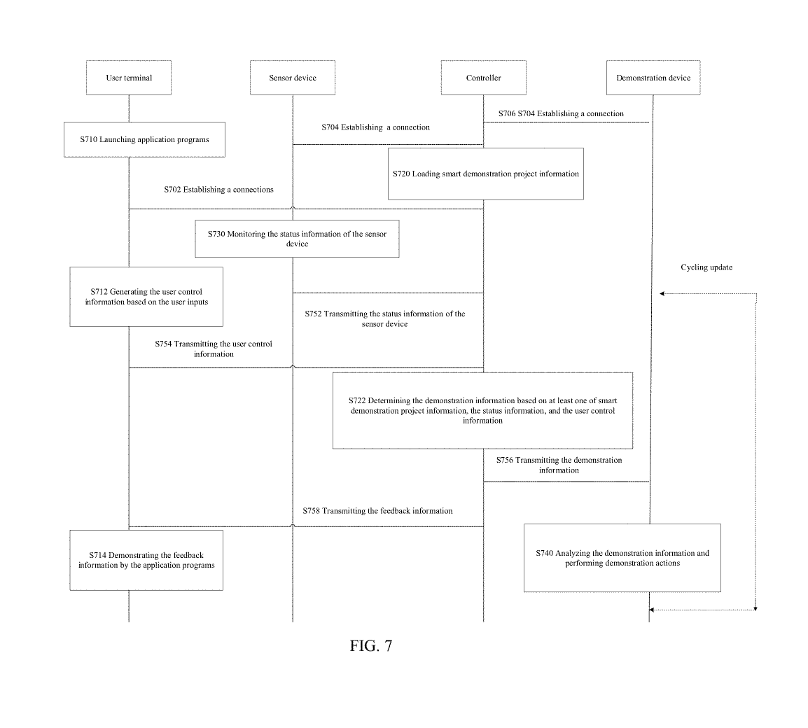

FIG. 7 illustrates another smart table demonstration method according to various embodiments of the present disclosure. The sand table demonstration method may be used in various embodiments of the sand table demonstration apparatus illustrated in FIGS. 1-5. The executive entities of the method may include a user terminal, a sensor device, a demonstration device and a controller.

In the startup phase of the smart sand table demonstration apparatus, connections between the sensor device and the controller is established (in Step S704 in FIG. 7); connections between the demonstration device and the controller is established (in Step S706 in FIG. 7); and the smart demonstration project information is loaded (in Step S720 in FIG. 7). In various embodiments, the controller may collect the models of the sensor device and the demonstration device that is connected, and then determine the demonstration projects that may be started according to the models of the connected devices and the preset information for each demonstration project. For example, the demonstration project 1 need a sensor 1 and a projector 1; while the demonstration project 2 need a sensor 2, the projector 1 and a response device 1. The controller can decide whether to start the demonstration project 1 or the demonstration project 2 according to the connected devices. In other embodiments, administrators may manually select the demonstration projects to be loaded by the controller, and the controller may detect whether all necessary devices are online and respond normally according to the lists of the necessary devices for the target demonstration projects. In the startup or demonstration phase, the controller may display corresponding prompt messages to remind the administrators to check the abnormal devices, when abnormal or missing devices are detected.

The user terminal may start demonstration application programs as illustrated in Step S710 in FIG. 7, and a connection between the user terminal and the controller may be established as illustrated in Step S702 in FIG. 7 subsequently. The user terminal may establish the connection with the controller at any time (in the startup phase or the demonstration phase). The application programs may provide introduction related to the smart sand table demonstration projects, and may also provide controlling options and feedback interfaces. In other embodiments, it is unnecessary to install specific application programs in the user terminal, and the similar functions as the application programs (such as querying demonstration information, sending control information to the controller, receiving feedback information from the controller, and so on.) may be accessed by visiting preset websites in a cloud server. In this case, the application programs mentioned in Steps S710-714 may refer to browsers or other programs for visiting preset websites.

In the demonstration phase, the sensor device may monitor its own status information (in Step S730 in FIG. 7) and then transmit the status information to the controller (in Step S752 in FIG. 7). The user terminal may generate user control information according to user inputs received by the user interfaces of the application programs (in Step S712, in FIG. 7). User inputs may have different forms. For example, the user interfaces may provide input requirements related to the demonstration projects, and instruct users to make a selection, input some text, take a photo, scan a piece of code, record an audio or shake the terminal. The user terminal may collect the control information based on the user inputs and send the control information to the controller. The controller may determine the corresponding demonstration information or the feedback information based on at least one of the smart demonstration project information, the user control information and the status information (in Step S722 in FIG. 7). The controller may send the demonstration information to the demonstration device (in Step S756 in FIG. 7) or send the feedback information to the user terminal (in Step S758 in FIG. 7).

The user terminal may display the feedback information through the application programs after receiving the feedback information (in Step S714 in FIG. 7). For example, the application programs may display animations and texts, play sounds, vibrate, and so on. The demonstration device may analyze the demonstration information and execute corresponding demonstration actions when the demonstration information is received.

The controller may respond to the events of the sensor device or the user terminal, and then may instruct the demonstration device to demonstrate information and/or send the feedback information to the user terminal. This may complete one interactive demonstration. The process (Step S730 to Step S758 in FIG. 7) may repeat, and the controller may continuously respond to various interactive queries and instruct the demonstration device to complete interactive demonstrations. In various embodiments, the controller may interact with the sensor device, the demonstration device and the user terminal by means of push/pull to exchange information data, but it should not limit the scope of the present disclosure.

In various embodiments, the controller may be connected to the cloud server, and may control other devices through the cloud server. The user terminal with administrative authority may be connected with the controller through the cloud servers to check the status of the demonstration projects (including the information from the sensor device and the demonstration device) or to modify the information of the demonstration projects. The user terminal watching the demonstration may attend the demonstration projects by being connected to the cloud server.

In the smart sand table demonstration apparatus provided by various embodiments of the present disclosure, the sensor device and the response device may be placed on the sand table base, while the projecting device may project demonstration information onto the sand table base. Further, the controller may determine the demonstration contents based on the smart demonstration project information and the user interactive information of the sensor device, and then the corresponding response devices or the projecting device may perform the demonstration actions. The operation of the smart table demonstration apparatus provided by various embodiments of the present disclosure is simple, and the interactive experience is intuitive. The smart table demonstration apparatus may provide a large expanding space for interactive sand tables, and may meet a large variety of demonstration needs. The sensor device and response device may be wirelessly connected to the controller, to send and/or receive data, so the complex wiring and physical connecting ports are avoided. One controller may remotely control multiple different types of interactive demonstration projects. So the layouts of the sand tables are simplified and a large variety of demonstration effects is achieved. The user terminal may also interact with the sand table demonstration apparatus to control the response devices or to display interactive information. So the interactive strength and the user experience is improved, and a better demonstration effect is achieved.

The smart sand table demonstration apparatus provided by various embodiments of the present disclosure may be used to demonstrate the scenery of Internet of Things (IoT). For example, the sand table may include multiple typical application scenes of IoT which may be used as a base of module integration. In real demonstrations, the sensor device and the demonstration device using different functional modules may be combined according to different demonstration topics. The apparatus may include: sand table scenes, one or more IoT devices (such as a demonstration device, a sensor device, and mobile devices, which including wireless communication modules 510 and functional modules), software service terminals (servers or controller 140), and cell phone APPs for interactions. The power sources and sensors may be deployed in the sand table to simulate typical IoT scenes. The IoT devices may be composed of external models (such as static sand table scenery structures), modular smart hardware and sensors. The IoT devices may further include WiFi modules or Bluetooth modules and may detect the scenery environment and interact with the sand table scenes. The IoT devices may collect the information or detect events through the sensors, and may send this information to the software service terminals. The software servers may be responsible for handling interactive logics between the IoT devices, the cloud servers, and the cell phones, to integrate the whole sand table apparatus.

Some examples of smart demonstration projects based on the smart sand table demonstration apparatus and methods provided by various embodiments of the present disclosure may be provided below.

### EXAMPLE 1: SMART PARKING LOT DEMONSTRATION APPARATUS

A smart parking lot demonstration apparatus may be implemented using light illuminating sensors. When a parking lot is occupied (i.e. the light illuminating intensity detected by a light illuminating sensor is smaller than a specific threshold value), the status information of the sensor device is “using=true”; while when a parking lot is available (i.e. the light illuminating intensity detected by a light illuminating sensor is larger than a specific threshold value), the status information of the sensor device is “using=false”. The light sensor may detect the change of the light every one second. If a change of the status is detected, the light sensor may send the status data to the server (i.e., the controller 140). If no change in the status is detected, the light sensor may send “JSON” information to the server every 10 seconds.

The server may respond to generate demonstration information or feedback information, after receiving the information from the light illuminating sensor. For example, in a demonstration scene for counting the parking lots in a parking garage, the server may counting the status of a plurality of light sensor, to determine the number of the available parking lots which may be used as the demonstration information to be displayed in the indication panel or to be displayed by projecting device in the parking garage model. In another example, in a demonstration scene for a smart house demonstration, the server may remotely turn on smart lamps in rooms, since the occupied parking lot indicates somebody is home. Further, the server may send corresponding feedback information to the user terminal when the user terminals query the server for the status of this parking lot.

### EXAMPLE 2: SMART DOOR LOCK DEMONSTRATION APPARATUS

A smart door lock demonstration apparatus may be implemented by NFC sensors, servos, Hall sensors and magnets. When the mobile props or user terminal with NFC chips approaches, the servos may be driven to open the doors and then to close the doors automatically after 10 seconds. The Hall sensors and magnets may be used to determine whether the doors and windows are closed or not, and then modify the corresponding status information to “opening=false” or “opening=true”. The Hall sensors may be configured to check the status every 1 second. If a change in the status variable “opening” is detected, the sensor may send the status data to the server in time. If no change in the status is detected, the sensor may send “JSON” information to the server every 10 seconds. The smart lock demonstration apparatus may further support controlling from the server. When the locks receives an instruction (such as the opening instruction sent by the user terminal through the server), the locks may determine whether the servos may be driven to open the doors based on the current status of the variable “opening” (the servo needs to be driven to open the door if the variable “opening” is false, but does not need to be driven if the variable “opening” is true). The above function may be implemented through the code below:

{cmd:“cm”,token:“%device_secret_token%”.open:“true/false”}.

A smart window demonstration apparatus may be implemented by the same principle.

### EXAMPLE 3: SMART SECURITY ALARM DEMONSTRATION APPARATUS

A smart security alarm demonstration apparatus may be implemented by PIR sensors and buzzers. The security devices may include PIR sensors, and report the current security status to the cloud server every 10 seconds. The cloud server may control the start or stop of the security devices.

The smart security alarm demonstration apparatus may be combined with the smart parking lot demonstration apparatus. For example, when the smart parking lot is empty, the cloud server automatically determine a state that the owner is out of the home and then start the security devices. After starting the security devices, the buzzer may sound an alarm for 10 seconds and send an alarm information to the server, if the PIR sensor detects infrared motion. The server may send an alarm to a cell phone after receiving the alarm information.

The smart security alarm demonstration apparatus may also be combined with the smart lock demonstration apparatus. After starting the security devices, the buzzer may sound alarmed for 10 seconds and send an alarm information to the server, if the smart lock detects that a door is open. The server may send an alarm to a cell phone after receiving the alarm information. Similarly, after starting the security devices, the buzzer may sound an alarm for 10 seconds and send an alarm information to the server, if the smart lock detects that a window is open. The server may send an alarm to a cell phone after receiving the alarm information.

The smart security alarm may support controlling from the server. The server may start or stop the security devices according to the value of the variable “enable”. The above function may be implemented through the code below:

{cmd:“cm”,token:“%device_secret_token%”,enable:“true/false”}.

When the security devices are started and the control information from the cloud server is received, the buzzer may be driven to sound alarm for ten seconds according to the value of the variable “warn” (the value of the variable “warn” may be modified based on the status of the PIR sensor, the status of the smart lock and the smart window). The above function may be implemented through the code below:

{cmd:“cm”,token:“%device_secret_token%”,warn:“true/false”}

### EXAMPLE 4: ENERGY MONITORING DEMONSTRATION APPARATUS

An energy monitoring demonstration apparatus may be implemented using pressure sensors, LED lights and projecting devices. Windmill models may be placed on the sand table base, and may be connected to the pressure sensors. LED light bands may be deployed on the windmill models (for example, LED light bands may be deployed on the windmill blades or on the basements of the windmills as progress bars). When performing the interactive demonstration, users are instructed to have a deep breath and then blow the windmills. The data may be collected based on the pressure and duration of the users' blowing on the windmills, and the power generated by the users may be computed. The sampling happens every 2 seconds. Then the LED light may be turned on based on the data of the pressure and duration detected by the pressure sensors, and the length and colour of the LED light band which is turn on indicates the amplitude of the generated power. The demonstration of the data may be feedbacked directly on the windmill modules, or the audiences/users may take pictures with their own results and records. The data may also be displayed in the video. The personal power generation in this time and a comparison with other power stations (for example, displaying “You beat n % of the power stations) may be displayed by projecting devices. Top ten users in the power generation, the power generated cumulatively and the total number of the power stations may also be displayed.

### EXAMPLE 5: CLOUD SERVER AND LOCAL ENVIRONMENT MONITORING DEMONSTRATION APPARATUS

A cloud server and local environment monitor demonstration apparatus may be implemented by temperature sensors, humidity sensors, atmosphere pressure sensors, and light sensors deployed in the demonstration space. In the phase of retrieving data, the server collects the weather information in the space including temperature, humidity, pressure, light intensity, PM value, and so on, according to the status information of each sensor. The server is connected with the cloud server, and may obtain the weather information (including rain/sunny, temperature, humidity, and so on) where the users are interested according to the internet weather service. In the phase of demonstration data, the weather information may be demonstrated by projecting devices, web interfaces or APPs, after the server obtains the required weather information.

### EXAMPLE 6: LUNAR RACING FIELD DEMONSTRATION APPARATUS

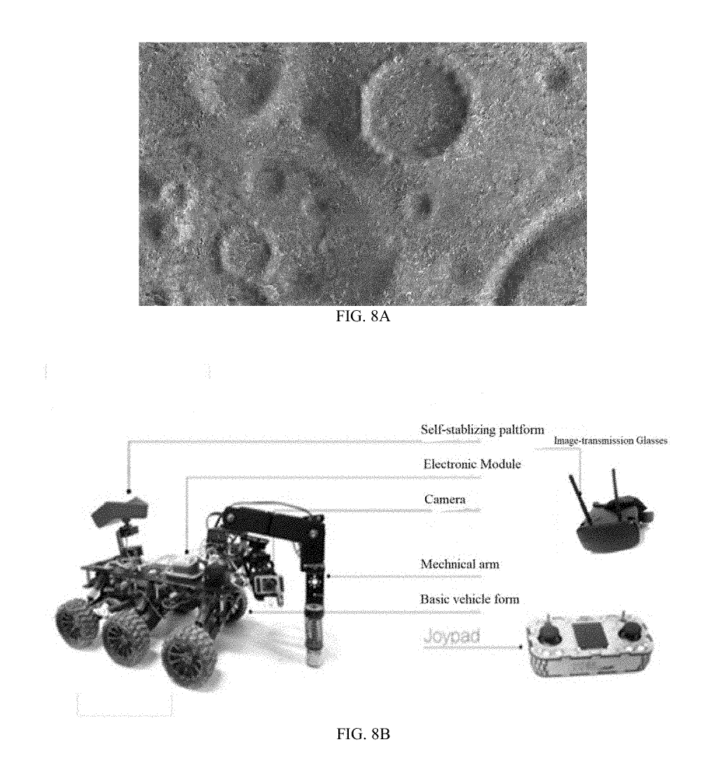

FIG. 8A illustrates a top view of the sand table base of a lunar racing scene demonstration project. The sand table base demonstrates the structure of lunar potholes, providing a racing field. FIG. 8B illustrates mobile props used for the lunar racing scene demonstration project. FIG. 8B shows a lunar rover for racing which may include a six-wheel-remote-driven apparatus, an electromagnetic manipulator, a searchlight, an image transmission camera, electronic modules, an infrared aiming apparatus, a self-stabilizing collecting platform and other components. A remote device Joypad may be used to control the lunar rover to move or collect stuff using the manipulator. Images captured by the camera in the lunar rover may be transmitted to a display helmet (image transmission eyeglasses in FIG. 8B) in real time. The main task of the competition is controlling the lunar rover to collect useful minerals (meteorites) by the image transmission apparatus and the 2.4G remote controller, and to send the meteorites back by the self-stabilizing platform apparatus to the base within a specific time period through the various complex. bumpy roads. The electromagnets may be used to detect and collect the meteorites. The electronic modules in FIG. 8B may adopt the structure of the mobile props in FIG. 5, including wireless communication module 510 to communicate with the controller 140. In various embodiments, a plurality of the lunar rovers may form a self-organized network.

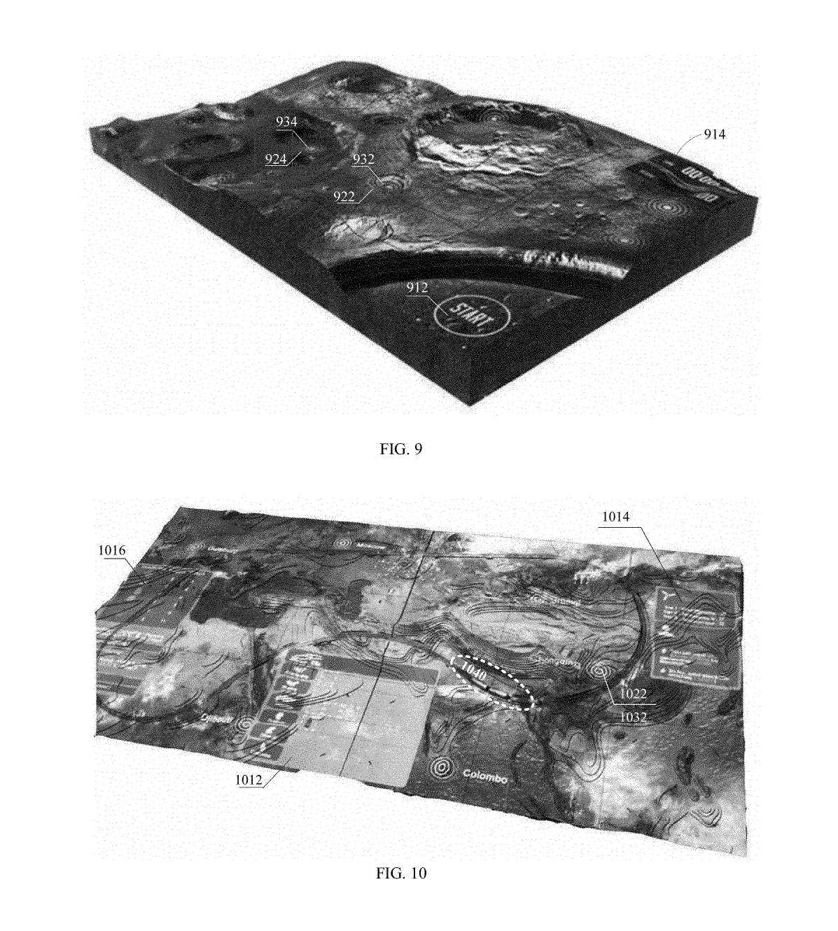

FIG. 9 illustrates a three-dimensional structure of a lunar rover scenery sand table. After adding the projecting effects from the projecting devices, the field is ready for use. The projection mark 912 can designate the starting point of the competition, and the projection mark 914 can update the competition time in real time after the competition begins. A plurality of circular projecting mark may be also shown on the sand table, and the circular projecting marks with different colours may designate the mining points (such as the projecting marks 922) and the opportunity points (such as the projecting marks 924). The positions of the circular projecting marks may be different in different competitions, which may improve the interests of the matches. In each competition, operators may control the lunar rovers by the image transmission apparatus and the remote controllers in a designated operating region, while other members may directly observe the map and provide reference information to the operators in the meantime. Sensors (including Hall sensors or light sensors) may be deployed in the opportunity points. When the operators control the lunar rovers to stop in one of the opportunity points (such as the position of the projection mark 924), the status of the sensor in the point may change and may be sent to the server, while the sever may control the projecting devices to blink the corresponding circular mark for 3 seconds (such as to blink the projecting mark 924), based on the sensor number and the position of the corresponding circular mark. The server may also record that the corresponding team achieves an opportunity reward, and different opportunity points may correspond to different rewards. Magnets may be deployed in the mining points. When the operators control the lunar rovers to arriving at the mining points (such as the position of the mark 932), the lunar rovers may collect the magnets (minerals) by the mechanical arms. Minerals in different reward points with different difficulty for mining may correspond to different scores. The operators may collect the minerals to the self-stabilizing platforms by the electromagnets and transport them back to the bases to achieve scores.

The above racing field model makes comprehensive use of smart electronic modules, sensor technology, Internet of Things technology and interactive projector technology, to construct an interactive racing field combing the virtual and realistic effects. In the racing field of the present demonstration project, the system may include a racing field, racing device(s), a software server, a projector for effect demonstration. The racing field may show the rendering effect by the projector. Power sources, sensors, and integrated network modules (such as the wireless communication modules 510) may be deployed in the racing field for transmitting status and receiving control signals. The racing devices also may include integrated network modules for transmitting status and receiving control signals. The racing devices may form a self-organized network or may be directly connected to each other by a router. The racing field and the racing devices may send the status of themselves to the software sever to form an aggregation of the field information. The software server may receive the status of the racing field and the racing devices, and control the projector to demonstrate a variety of visual effect and control the actions of the devices in the racing field, according to the racing rules.

### EXAMPLE 7: LOGISTICS SAND TABLE FOR BELT AND ROAD (B&R) INITIATIVE DEMONSTRATION APPARATUS

FIG. 10 illustrates a three-dimensional effect of a sand table demonstration apparatus for logistics in the B&R initiative. The three-dimensional sand table base may be constructed according to the geographical profile of the B&R, at least showing the elevation effect of the various sections. The train track models may also be deployed in the sand table base. The geomorphological and weather information may be added in the projection on the sand table base, showing the positions of lakes, the information of deserts and vegetations in various sections. The train models 1040 may be used as the mobile props in the sand table, and may move along the train track models to transport virtual goods between train stations along the train tracks. Each train station may be labelled with a name using a projecting mark. For example, the projecting mark 1022 labels Chongqing train station. Sensors may be deployed in each train station and may be buried below the train tracks inside the sand stable base, as illustrated by the point 1032. The sensors may be used to determine whether trains arrive at the corresponding train station and to send the status information to the server (the controller 140). The server may determine which station a train arrives currently based on the status information from sensors corresponding to each trains station. The server may also remotely control the startup and stop of the train models 1040. The demonstration project may be performed in a demonstration mode and an interactive mode. In the demo mode, the trains may stop at every train station and then start up after a preset time period automatically. In the interactive mode, users may send out instructions through APPs, and the server may control the startup and stop of the train after receiving the instructions.

This sand table demonstration project can set a special good for each train station: Chongqing (China): hotpot; Urumqi (China): fruits; Moscow (Russia): matryoshka; Duisburg (Germany): beer; Colombo (Sri Lanka): Black tea; Nairobi (Kenya): Black wood carving. Each train station may have a freight yard. Virtual goods in the freight yards may be in one of the following statuses: “Deliverable”, “To be shipped”, “To be received”, “In transit”, “Delayed”, “Arrived”, and “In freight handling and transportation”.

The server may maintain various variables corresponding to the logistics and transportation, such as the categories and numbers of goods in each trains station, the number of goods carried by the trains, categories and corresponding destinations of goods, current stop stations of the trains, and the transportation status of each good. The server may update values of the corresponding variables based on different interactive scenes (such as the status of the sensors in the corresponding trains stations, and the controlling information from the APPs in cell phones), and then send the corresponding demonstration information to the projecting devices for display. For example, the projecting information 1012 in FIG. 10 shows the categories and numbers of the goods carried by the current trains; the projecting information 1014 shows introductions to the destination city of the current trains; and the projecting information 1016 shows the cargo situation of each train station and other update information. The information display panels may be displayed in videos by project, and may be fixed-height scrollable information boxes which may hold up to 200 lines of texts.

Abnormal events may also be set up in the demonstration. A plurality of virtual roadblocks representing the abnormal events may be deployed in the sand table railway. These events may include: heavy snowfall (Russia), typhoon (Persian Gulf), loss of goods (places not limited). If meeting a roadblock, the status of the goods in transit on the train may be changed to “delayed” in the sending station and receiving station. When routing failure happens, the fault information may be displayed on the display panel. If a train arrives at this location during a roadblock, the train automatically stops and waits. The stop of a train may send a train delay information to the information display panel. When a recovery button is pressed, the turntable changes to “unblocked” and a train arriving at this location goes through smoothly.

A situation for lost goods may be also set up in the demonstration project. A cargo loss device similar to a slot machine may be deployed on the sand table railway or a virtual goods loss device may be set up in the APP. The audiences may press the button to randomly select one good in transit whose status may be changed too “Lost” from “In transit”.

According to different user interaction and train logistics, the server may make specific treatment. When the goods are in a “Deliverable” status, audiences can send the virtual goods to other destination stations. Once the audiences choose to send a virtual good to a station, the status of the goods at the delivery station is changed to “To be Delivered” and the goods are added at the destination station where the status of the good is “To Be Received”.

When trains arrive at stations, the following process may be applied on the goods in a status of “Lost”: the corresponding status of the goods in the delivery station and the destination station is changed to “Lost”, and then the goods are deleted from the delivery station and the destination station after the information blinks three times; the goods the goods in a status of “Lost” on the trains are deleted; in the initial station of the goods, the goods are changed to “deliverable” to replenish supply. When trains arrive at stations, the following process may be applied to the goods arrive at the station: the corresponding status of the goods in the delivery station is changed to “Arrived”, and then the goods are deleted from the delivery station after the information blinks three times; the status of the goods is changed to “deliverable” in the destination station and the goods on the trains are deleted. When trains leave stations, the following process may be applied to the goods arrive at the delivery stations: the corresponding status of the goods in all delivery station is changed to “In transit”; modify the list of goods on the trains to add the goods that are delivered; the status of the goods is changed from “To he received” to “In transit” in the destination station.

This sand table demonstration apparatus for logistics in the B&R initiative integrates the remote controlling function, and provides a large variety of interactive sessions and direct demonstrations, which is very interesting.

In the smart sand table demonstration apparatus provided by various embodiments of the present disclosure, the sensor device in the sand table is wirelessly connected to the controller, and wiring for a complex layout is avoided, providing more creative space and possibility for constructing sand tables for various demonstration projects.

For the electronic modules used in various embodiments of the present disclosure (such as wireless communication modules 510 and functional electronic modules), one or more electronic chips may be deployed in a PCB board to form an integrated circuit board, and then the shells may be assembled with the integrated circuit board to form an electronic module. The electronic modules may further include magnets to magnetically connect the current electronic module to other electronic modules.

Any suitable electronic chips or IC chips may be integrated into to the circuit boards of the corresponding modules by pre-assembling or other methods. The examples of the electronic chips include but are not limited to: microcontroller units (8-bit, 16-bit and 32-bit) ARM CPU, MIPS CPU, USB2TTL, Ethernet, RS485, USB Host, wireless 2.4 GHz, wireless 433 MHz, wireless 866 MHz, wireless 950 MHz, wireless Bluetooth ZigBee, NFC, Micro SD, GPS, GPRS/GSM, 4G/LTE, wireless chargers, MP3 decoders, amplifiers, Organic Light Emitting Diodes (OLEDs), motor drivers, stepper drives, (real time clock) RTC, accelerometer, gyroscopes, magnetic field strength, Lithium battery managers, dual-board, Arduino to Microduino pin transductions, skin current sensors, Arsenic detectors, resistors, capacitors, inductors, and/or others chips which are provided in the same or different modules for making the desired electronic modules.

Each electronic module may perform one or more functions (such as one LED, one button, one light sensor, and so on), and these modules may be combined to form bigger circuits. Some modules may respond to external events such as mechanical forces, touching, approaching, RF signals, environmental conditions, and so on. Some other modules may be pre-programmed as functional modules such as synthesizers, oscillators, and so on. Some other modules may be used to transfer currents only, such as lead modules. The rest modules may be used to provide currents, such as power blocks or modules. The modules may further include adapter boards, which is used to construct apparatus (electronic building block apparatus) with other electronic modules and for matching the interfaces.

The functional electronic modules in various embodiments in the present disclosure may have standard ports which match the external ports of wireless communication modules 510. When any one of the functional electronic modules is connected to the wireless communication module 510, this functional electronic module may communicate with the controller 140 for information exchange through the wireless communication module 510.

The functional electronic modules in various embodiments in the present disclosure may be connected with each other. For example, the integrated circuit board may include electrical conductors (such as metallic probes and pin connectors) for current transmission between neighbouring modules. The pin connectors may use spring probes to prevent damage in operations and to increase the service life of the modules. The pin connectors may include any numbers of spring probes in any arrangement, and may be used for current conducting and/or electronic communication between one module and the next module. For example, the pin connectors may be spring probes such as pogo pins, to ensure the connection between the stacking modules. In one embodiment, pogo pins may include 27 pogo pins arranged in a U shape, about 44 pogo pins arranged in an H shape, or about 88 pogo pins arranged in an H shape. This should not limit the scope of the present disclosure and any other methods for current conducting and electronic information communication between the modules are within the scope of the present disclosure.

The smart sand table demonstration apparatus provided by various embodiments of the present disclosure may be used in a large variety of demonstration projects, such as science/education projects, building demonstrations, and so on. The smart table demonstration apparatus combines the static scenery structures of the sand tables with the sensor devices and the demonstration device, providing a large creation and design space. Interactive experience and intuitive demonstration are achieved. The sensor devices and response devices may be wirelessly connected to the controller, to send and/or receive data, so the complex wiring and physical connecting ports are avoided. One controller may remotely control multiple different types of interactive demonstration projects. So the layouts of the sand tables are simplified and a large variety of demonstration effects is achieved. The user terminals may also interact with the sand table demonstration apparatus to control the response devices or to display interactive information. So the interactive strength and the user experience is improved, and a better demonstration effect is achieved.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. A smart sand table demonstration apparatus, comprising:
a sand table base; a sensor device; a demonstration device; and a controller,
wherein:
the sand table base is used as a demonstration carrier for the demonstration device,
the sensor device is placed on the sand table base and includes a sensor module and a first wireless communication module for monitoring a status of the sensor module and transmitting status information to the controller through wireless connections,
the controller determines demonstration information based on at least one of smart demonstration project information and the status information of the sensor module, and transmits the demonstration information to the demonstration device, and
the demonstration device analyzes the received demonstration information and performs demonstration actions corresponding to the demonstration information.

2. The apparatus according to claim 1, wherein:
the demonstration device includes a projecting device, and the demonstration information includes projecting information; and
the projecting device receives the projecting information from the controller and projects the projecting information onto the sand table base.

3. The apparatus according to claim 1, wherein:
the demonstration device includes a response device and a second wireless communication module for receiving the demonstration information from the controller and transmitting the demonstration information to the response devices wirelessly; and
the response device is placed on the sand table base and performs the demonstration actions based on the demonstration information.

4. The apparatus according to claim 3, wherein:
the response device is one or more of a display, a media player, an LED lamp, a buzzer, a speaker, and a motor.

5. The apparatus according to claim 1, wherein:
the sensor module includes one or more of a temperature sensor, a humidity sensor, a light illuminating sensor, an air quality sensor, a human body sensing sensor, a color identifying sensor, a proximity sensor, a collision sensor, a posture sensor, a heart rate sensor, a gesture sensor, an ultrasonic sensor, a Hall sensor, a voice collector, and an image collector.

6. The apparatus according to claim 3, wherein:
the first wireless communication module and the second wireless communication module establish a communication with the controller by one or more of a Bluetooth wireless connection, an infrared wireless connection, and a WiFi wireless connection.

7. The apparatus according to claim 3, further including:
a plurality of sensor devices and a plurality of the demonstration devices, wherein:
the first wireless communication module is configured to establish a wireless network system including the plurality of the sensor devices;
a first wireless communication module of one sensor device has a wireless connection with a first wireless communication module of another sensor device;
the second wireless communication module is configured to establish a wireless network system including the plurality of the demonstration devices; and
a second wireless communication module of one demonstration device has a wireless connection with a second wireless communication module of another demonstration device.

8. The apparatus according to claim 1, wherein:
the controller further receives user control information from a user terminal, and determines the demonstration information based on one or more of the smart demonstration project information, the status information, and the user control information; and
application programs corresponding to the smart sand table demonstration apparatus are installed on the user terminal and user interfaces provided by the application programs generate the user control information based on user's inputs.

9. The apparatus according to claim 8, wherein:
the controller further determines feedback information based on one or more of the smart demonstration project information, the status information, and the user control information, and transmits the feedback information to the user terminal; and
the feedback information is demonstrated on the user terminal by the application programs in a form including one or more of display, sound, and vibration.

10. The apparatus according to claim 9, wherein:
the controller and the user terminal are connected to a cloud server respectively; and
the controller and the user terminal communicate with each other through the cloud server.

11. A smart sand table demonstration method using an apparatus including a sand table base, a sensor device, a demonstration device, and a controller, the method comprising:
establishing a wireless connection between the controller and the sensor device, the sensor device is placed on the sand table base;
establishing a connection between the controller and the demonstration device, wherein the demonstration device has a demonstration carrier including the sand table base;
loading smart demonstration project information;
receiving status information monitored and collected by the sensor device;
determining demonstration information based on one or more of the smart demonstration project information and the status information; and
transmitting the demonstration information to the demonstration device for analyzing the demonstration information and performing demonstration actions corresponding to the demonstration information.

12. The method according to claim 11, further including:
receiving status updating information of the sensor device;
determining the demonstration updating information based on the status updating information and the smart demonstration project information; and
instructing the demonstration device to perform demonstration updating actions based on the demonstration updating information.

13. The method according to claim 11, further including:
receiving user control information from a user terminal, wherein application programs corresponding to the smart sand table demonstration apparatus are installed on the user terminal and user interfaces provided by the application programs generate the user control information based on user's inputs; and
determining the demonstration information based on one or more of the smart demonstration project information, the status information, and the user control information.

14. The method according to claim 13, further including:
determining feedback information based on one or more of the smart demonstration project information, the status information, and the user control information; and
transmitting the feedback information to the user terminal, wherein the feedback information is demonstrated on the user terminal by the application programs in a form including one or more of display, sound, and vibration.

15. The smart sand table demonstration method according to claim 13, wherein
the controller and user terminals are connected to a cloud server respectively; and
the controller and user terminals communicate with each other through the cloud server.

16. The method according to claim 11, wherein:
the demonstration device includes a projecting device, and the demonstration information includes projecting information; and
the projecting device receives the projecting information from the controller and projects the projecting information onto the sand table base.

17. The method according to claim 11, wherein:
the demonstration device includes a response device and a second wireless communication module for receiving the demonstration information from the controller and transmitting the demonstration information to the response devices wirelessly; and
the response device is placed on the sand table base and performs the demonstration actions based on the demonstration information.

18. The method according to claim 11, wherein:
the response device is one or more of a display, a media player, an LED lamp, a buzzer, a speaker, and a motor.

19. The method according to claim 11, wherein:
the sensor module includes one or more of a temperature sensor, a humidity sensor, a light illuminating sensor, an air quality sensor, a human body sensing sensor, a color identifying sensor, a proximity sensor, a collision sensor, a posture sensor, a heart rate sensor, a gesture sensor, an ultrasonic sensor, a Hall sensor, a voice collector, and an image collector.

20. The method according to claim 11, wherein:
the apparatus further includes a plurality of sensor devices and a plurality of the demonstration devices;
the first wireless communication module is configured to establish a wireless network system including the plurality of the sensor devices;
a first wireless communication module of one sensor device has a wireless connection with a first wireless communication module of another sensor device;
the second wireless communication module is configured to establish a wireless network system including the plurality of the demonstration devices; and
a second wireless communication module of one demonstration device has a wireless connection with a second wireless communication module of another demonstration device
